(19) United States
(12) Patent Application Publication
(10) Pub. No.: US 2005/0008446 A1
(43) Pub. Date: Jan. 13, 2005

(54) Torque controlling fastener

(76) Inventor: Joe Allen, El Monte, CA (US)

Correspondence Address: ROBERT J. SCHAAP, Suite 188, 21241 Ventura Boulevard, Woodland Hills, CA, 91364, US

(21) Appl. No.: 10/705,117

(22) Filed: Nov. 10, 2003

Related U.S. Application Data
(60) Provisional application No. 60/425,066, filed on Feb. 6, 2003.

(51) Int. Cl. F16B 39/28

(52) U.S. Cl. 411/332

(57) ABSTRACT

A torque limiting nut comprising a nut cap and a nut base with axially aligned bores to receive a fastener such as a bolt. The base and the cap are constructed so that the two engage one another in such manner that opposed and serrated surfaces on one or both of the base and the cap cause the two to rotate together about a threaded bolt or stud until a predetermined torquing force is reached. Thereafter, one of the cap or base will slip relative to the other allowing for rotation of one relative to the other. In this way, a required torque level can be applied to the nut to cause a rotation thereof on a threaded shank of a bolt or other fastener until that predetermined torque force has been reached.

### RELATED APPLICATIONS

This application is based on and claims for priority, the filing date of my U.S. Provisional Patent application Ser. No. 60/425,066 filed Nov. 8, 2002, for Torque Limiting Fastener.

### BACKGROUND OF THE INVENTION

1. Field of the Invention

This invention relates in general to certain new and useful improvements in torque limiting fastener assemblies and, more particularly, to torque limiting fastener assemblies in which two components form part of the fastener assembly and are releasably connected to one another and also engage one another in such manner as to preclude an over-torquing of the assembly.

2. Brief Description of Related Art

There are a large number of applications in which fasteners such as nut assemblies and the like are used to secure two components together. Moreover, in many situations where nut-type fasteners were used, it is necessary to control the amount of torque applied to the nut in order to preclude over-torquing, frequently referred to as “over-wrenching”, the nut assembly.

One example of an application in which torque limiting nuts are used is in the securement of a head to an automobile engine. Very frequently the engine is constructed of steel, but the head may be formed of a softer material and one which is readily crushable or bendable, such as aluminum or the like. In that case, it is necessary to use a torque limiting wrench so that the nut or other fastener assembly so that an excessive amount of torque is not applied, that is so that the fastener assembly is not over-wrenched. Otherwise, over-torquing of the nut assembly could cause a crushing or cracking of the softer head.

Presently, there are two ways in which a nut can be secured to a bolt or a stud or other fastener assembly, while limiting the amount of torque applied to the nut or other fastener assembly. The first approach is to provide a fastening tool, such as a torque-limiting wrench, in which torque can be applied to a nut or other fastener with only a pre-determined amount of torque before further wrenching or turning of the fastener assembly cannot be achieved or otherwise becomes ineffective. The other approach is to provide a fastener which is constructed so that it cannot be turned and further tightened with torque when a pre-determined amount of torque has already been applied to that fastener.

In many cases, torque limiting wrenches are commonly used. These wrenches are typically provided with a gauge which shows the amount of torque imposed on a nut or other fastener assembly in foot pounds or other graduations. Thus, the user of the tool, such as the torque wrench, must carefully monitor the amount of torque by constantly viewing the gauge in order to avoid applying an excessive amount of torque to the fastener.

There are also several fastener devices which have been proposed for purposes of limiting the amount of torque which may be imposed on the fastener. Representative of such fasteners include those illustrated in U.S. Pat. No. 5,474,409 to Terry, and U.S. Pat. No. 4,729,703 to Sato, as well as U.S. Pat. No. 5,902,085 to Yuta. Another related fastener is shown in U.S. Pat. No. 5,409,338 to McKinlay, as well as U.S. Pat. No. 3,273,443 to Rubin. Each of the devices in these patents are limited in that they are sometimes difficult to employ, and difficult to secure to an upstanding stud. Moreover, many of these devices are adapted only for a combination. In other words, the bolt must be suitably designed to accept the nut and vice versa.

There has been a need for a torque limiting fastener having two components which are rotatable relative to one another but where one component can be releasably secured to the other component, causing a simultaneous rotation of both components until a predetermined torque is applied to one of those components.

### OBJECTS OF THE INVENTION

It is, therefore, one of the primary objects of the present invention to provide a torque limiting fastener, in the nature of a torque limiting nut, and which is easy to employ and is highly effective in use. This torque limiting nut is also easy to use, in that it comprises two components which are capable of being engageable with one another in such manner that one component rotates relative to the other when a predetermined amount of torque is applied to the nut, but in combination the two provide an effective torque limiting tightening capacity before that predetermined amount is reached.

It is another object of the present invention to provide a torque limiting fastener of the type stated in which the torque limiting nut comprises a base and cap with the cap being rotatable relative to the base when a predetermined amount of torque is applied to the cap but which is rotatable with the base when torque not reaching that predetermined amount is applied, thereby providing an effective torque limiting nut.

It is a further object of the present invention to provide a torque limiting fastener of the type stated which is constructed so that the amount of torque required to rotate one of the components of the fastener relative to the other can be preset during the manufacture thereof and so that the fastener itself can be produced such that a specified amount of torque is required to cause slippage of the fastener relative to a bolt or stud when that preset amount of torque has been reached.

It is an additional object of the present invention to provide a torque limiting fastener of the type stated which can be constructed at a relatively low cost and which is highly effective in use. In this respect, the fastener is still highly effective when formed of simple molded plastic materials and can effectively replace like fasteners which were previously formed of steel and other heavy metals.

It is another salient object of the present invention to provide a method of limiting the amount of torque which can be applied to a fastener through the actual construction of the fastener. In this case, the method relies upon a two piece fastener with one piece slippable relative to the other when a predetermined amount of torque has been applied thereto.

With the above and other objects in view, my invention resides in the novel features of form, construction, arrangement and combination of parts and components presently described and pointed out in the claims.

### SUMMARY OF THE INVENTION

The present invention primarily relates to a torque limiting fastener comprised of two components, such as a fastener base and a fastener cap, cooperatable with the fastener base. These two components are capable of being releasably engageable with one another, so that one of the components is non-rotatable with respect to the other of the components when the torque applied to one or both of the components is less than a predetermined amount. However, one of the components becomes rotatable relative to the other of the components when the amount of torque does exceed a predetermined amount.

In a more preferred embodiment of the invention, the first of the components comprises a base having an axially extending bore for receiving a fastener such as a bolt or stud, a threaded rod or the like. The second of the components also has an axially extending bore for receiving that same fastener and in such manner that the mating fastener, such as the bolt or stud, extends through the aligned axially extending bores.

In a preferred embodiment of the invention, the fastener is that of a fastening nut which can be threadedly secured to an outwardly projecting bolt, stud or the like. The first of the components is a base and which is releasably engageable with the second of the components in the nature of a cap which is capable of mating with that base. Each of the base and the cap have opposed mating faces which are, essentially, engageable with one another. The nut, more specifically, has a base with a circularly shaped disc and upwardly extending projections, such as outwardly struck flanges. The cap is provided with a plurality of recesses or grooves arranged to receive the projections on the base. Alternately, the projections could be on the cap with recesses formed in the base. Either of these constructions are operable in connection with the present invention.

In effect, it is important for one of the components and, preferably, both of the components to have mating faces with serrated surfaces so that these serrated surfaces are engageable with one another. When the two mating faces of the cap and the base are disposed in mating engagement and the projections of one component extends into the recesses of the other component, a wrench or the like tool can be applied to the cap for imparting a torque force to the cap. As this occurs, the cap and the base will rotate together causing a tightening of the complete fastener about a stud or bolt projecting through the aligned bores. As long as the torque is below a certain predetermined force level, the cap and the base will rotate together as a torquing force is applied to the cap. However, when that torquing force exceeds a predetermined amount, the cap will slip relative to the base, such that the fastener will no longer turn.

The amount of force which is applied to the cap to allow the cap to slip relative to the base can be predetermined by properly controlling the size and shape of the grooves on one of the components and the projections on the opposed face of the other of the components. Thus, for example, by making the grooves deeper and the projections of greater dimension extending along the flat face of the component on which it is mounted, a greater amount of torquing force may be required. By properly tapering the recesses and the grooves, it is also possible to control the amount of torquing force required to permit slippage of the two components.

The grooves and the projections or, for that matter, other surface serrations on one component and on the other component, could be arranged so that rotation of the cap is prohibited below a certain predetermined amount of torquing force when rotated in one direction. However, slippage will completely occur when rotated in the opposite direction. Thus, when the cap is rotated in a clockwise direction relative to the base, a torquing force will cause the two to rotate together until that force reaches a predetermined amount. However, when rotated in a counter-clockwise direction, the cap can slip relative to the base and not cause any rotation thereof.

It should be understood that there could be rows of teeth on each of the opposed faces of the cap and the base so that the teeth engage one another but which teeth are shaped so that they will enable slippage to occur when a predetermined amount of force has been applied to the cap. In this respect, the teeth themselves actually form grooves so that the teeth on one face would fit within the grooves between two adjacent teeth projections on the other of the opposed faces. It should be understood that any type of construction which provides for engagement between the two components below a predetermined amount of force, can be used, but which will enable slippage when that predetermined force level has been exceeded.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is an exploded perspective view showing a torque limiting fastener in accordance with the present invention and being operatively disposed upon a bolt or shaft;

FIG. 2 is a perspective view of the underside of a torque limiting fastener cap forming part of the fastener of the present invention;

FIG. 3 is a top plan view taken substantially along the plane of line 3-3 of FIG. 2;

FIG. 4 is a perspective view of one form of base used with the cap of FIG. 2;

FIG. 5 is a top plan view of the upper surface of the base, taken substantially along the plane of line 5-5 of FIG. 2;

FIG. 6 is an exploded side elevational view showing the arrangement of the cap and the base prior to assembly;

FIG. 7 is a side elevational view, similar to FIG. 6, and showing the arrangement of the base and the cap relative to a threaded shaft;

FIG. 8 is a fragmentary sectional view showing the fastening engagement between the cap and the base of the fastener of the invention;

FIG. 9 is a sectional view, somewhat similar to FIG. 8, and showing a slightly modified form of the fastener of the invention;

FIG. 10 is a fragmentary side elevational view of the underside of a cap and the upper surface of a base in spaced apart relationship to show the interengagement between the two mating surfaces thereof;

FIG. 11 is a fragmentary plan view taken substantially along the plane of line 11-11 of FIG. 10;

FIG. 12 is a fragmentary side elevational view showing a modified form of tooth arrangement on the cap and the base of the fastener of the invention;

FIG. 13 is a fragmentary plan view taken along line 13-13 of FIG. 12;

FIG. 14 is a side elevational view of a further modified form of tooth arrangement on the underside of the cap and the upper surface of the base and which can be used in the fastener assembly of the present invention;

FIG. 15 is a fragmentary plan view taken along line 15-15 of FIG. 14;

FIG. 16 is a plan view of the underside of a cap forming part of the fastener of the invention showing a modified form of tooth construction;

FIG. 17 is a top plan view of the modified form of base forming part of the fastener of the present invention and used with the cap of FIG. 16; and

FIG. 18 is a fragmentary perspective view showing the tooth construction in the base of FIG. 17.

### DETAILED DESCRIPTION OF PREFERRED EMBODIMENTS

Referring now in more detail and by reference characters to the drawings which illustrate practical embodiments of the invention, T designates a torque limiting fastener assembly comprised of a base 20 and a cap 22. In the preferred embodiment of the invention, the fastener adopts the form of a nut which is capable of being tightened about a threaded shaft or bolt or stud 24 such that the fastener can bear against a surface 26 of a support member 28. The exact environment in which the fastener assembly of the invention will be used may vary but, generally, it is used in connection with mounting on a threaded shaft such as the shaft 24.

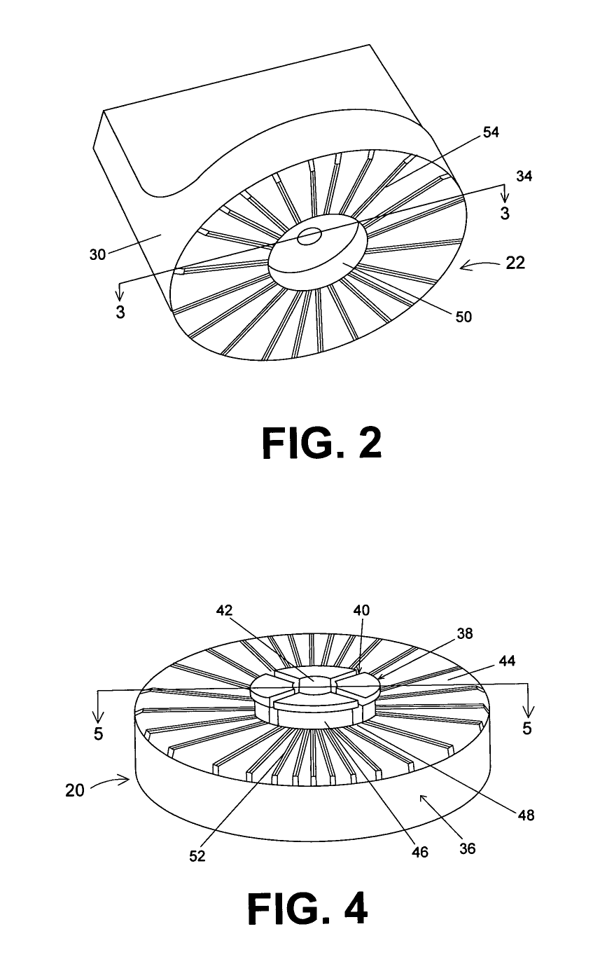

The cap 22 is comprised of a disc 30 having a downwardly presented surface 32 in the manner as best shown in FIG. 2 of the drawings. The disc 30 is also provided with an enlarged central opening 34 for receiving a threaded shaft or stud, such as the shaft 24.

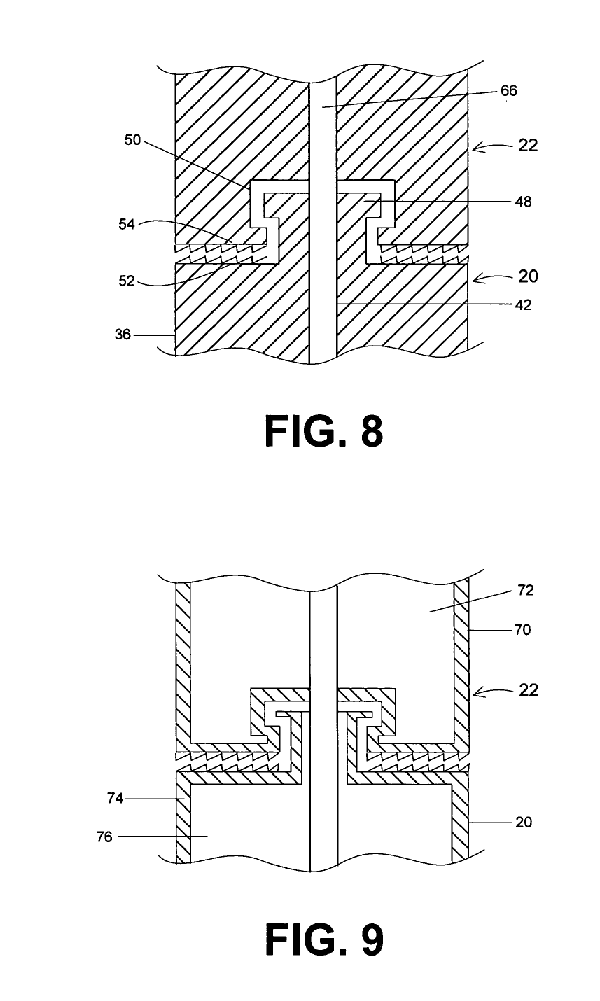

In accordance with these various illustrations, it can be seen that the base and the cap are adapted for mating engagement with one another, as hereinafter described. In this case, the cap will have essentially the same diametral size as the base and when the two are engageable with one another in the manner as best shown in FIGS. 7 and 8, then the cap will have a side wall located in essentially marginal registration with the side wall of the base.

Provided for interlocking cooperation with the nut cap 22 is a nut base 36 more fully illustrated in FIGS. 4 and 5 of the drawings. In this case, the nut base is provided with a disc 36, having a plurality of upstanding triangularly shaped hub sections 38. Each of the hub sections 38 are arranged so that they form a cylindrically shaped hub 40. Moreover, the hub 40 is constructed so as to be provided with a central opening 42. In this case, the central opening 42 is of a lesser diameter than the central opening 34 in the disc 30. However, the hub 40 is sized to fit within the opening 34 so as to enable a lower face 32 of the disc 30 to be in facewise engagement with an upper surface 44 on the disc 36.

Each of the hub sections 38 are triangularly shaped, that is pie-shape, in the manner as aforesaid. Moreover, each of these hub sections 38 is provided with an exterior wall 46 which is sized to engage the wall forming the opening 34. Moreover, each of the pie-shaped sections or hub sections 38 are provided with an outwardly extending peripheral flange 48 in the manner as best shown in FIG. 4 of the drawings. These flanges are sized to be snap-fitted into a cylindrically shaped groove 40 extending angularly around the interior surface of the opening 34. In this way, the hub cap 22 and the base 20 are constructed so that the flanges 48 will snap-fit into the angular groove 50 when forced into the opening 34. In actual construction, the flanges form a cylindrical ring slightly larger than the size of the opening 34 but will yield sufficiently to literally snap-fit into the angular groove 34.

When the cap 22 and the base 20 are essentially snap-fitted together in the manner as previously described, and in absence of any other structure, the cap would effectively rotate relative to the base 20. Moreover, if required, the cap could be pried apart from the base 20 by means of a screwdriver or other similar implement so as to separate the two components.

The upper surface 44 is provided with serrations 52 and in like manner, the lower surface of the disc 30 is provided with serrations 54. The exact form of serrations is hereinafter described in more detail. However, it can be observed that the serrations are such that they preclude the cap 22 from rotating relative to the base 20. In this way, if a rotatable force were applied to the cap 22, it would tend to cause rotation of the base 20. Thus, a torquing force applied to the cap will rotate the two components together, since the serrations on the mating surfaces will actually engage one another frictionally to preclude rotation of the cap relative to the base.

Depending upon the size of the serrations, the location of the serrations and the arrangement of the serrations, it is possible to control the amount of force required to permit slippage between the cap relative to the base. Thus, when a normal torquing force is applied to the cap, the two components will rotate together. However, when the torquing force exceeds a predetermined amount, the cap will rotate relative to the base and, in effect, no further tightening of the fastener will occur.

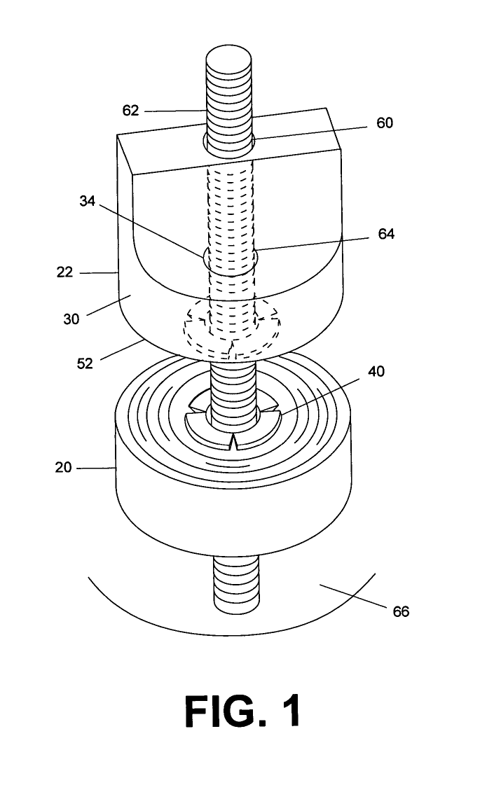

In order to enable the entire fastener to be secured to a complementary component, such as a bolt or a threaded stud, the interior surface of the cap or the base is provided with a threaded section which mates a threaded section on the shaft. Thus, and by reference to FIG. 1, it can be observed that there is a bolt 60 extending through the opening 42 in the base 20 and the opening 34 in the cap 22. In this case, the bolt is provided with a threaded shank 62 and which cooperates with internal threads 64 and the interior of the opening 34. In this way, when the cap 22 is tightened about the threaded shaft 60, it will rotate downwardly toward a mounting surface 66 as schematically illustrated in FIG. 1 and from which the threaded stud 60 is mounted. Thus, it can be seen that as further torquing action is applied to the cap 22, it will cause the base 20 and the cap to tighten relative to the mounting surface 60. However, when the cap 22 starts to rotate relative to the base 20, no further tightening action will result. In this case, the internal threads on the interior of the base and which mate with the thread 62 would cause the tightening action when the base rotates.

The cap 22 is also provided with a bolt receiving bore 66 sized to threadedly accommodate the threaded stud or bolt 60. Moreover, if desired this bore could be threaded so as to cause rotation of the two components together until the predetermined torquing level has been reached.

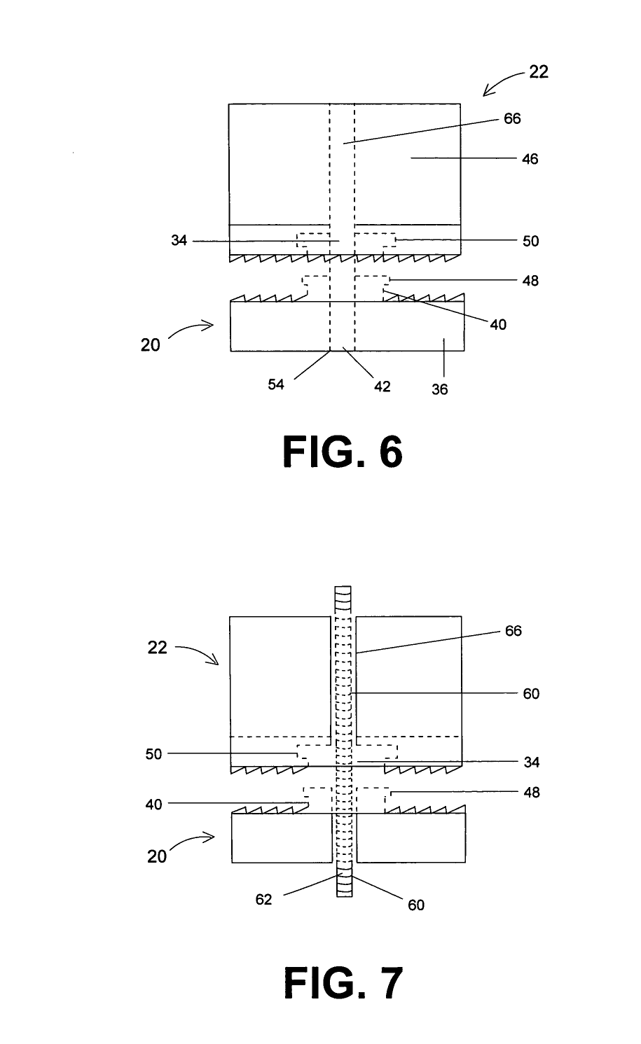

FIGS. 6 and 7 illustrate the components, such as the cap 22 and the base 20, in their spaced apart relationship prior to assembly. FIG. 7, more specifically, shows the receipt of the threaded shaft 60. FIG. 8 shows the completely assembled relationship of the two components.

FIG. 9 more fully illustrates an embodiment of the invention in which the two components, including a cap 221 and a base 201, which are of hollow construction. In this case, the cap is provided with an outer shell 70 and an interior open core 72. In like manner, the base is provided with an outer shell 74 and interior open core 76. Beyond this, the assembly of FIG. 9 operates in the same way as the previously described fastener. However, the assembly of FIG. 9 can only be used in lower torque operations.

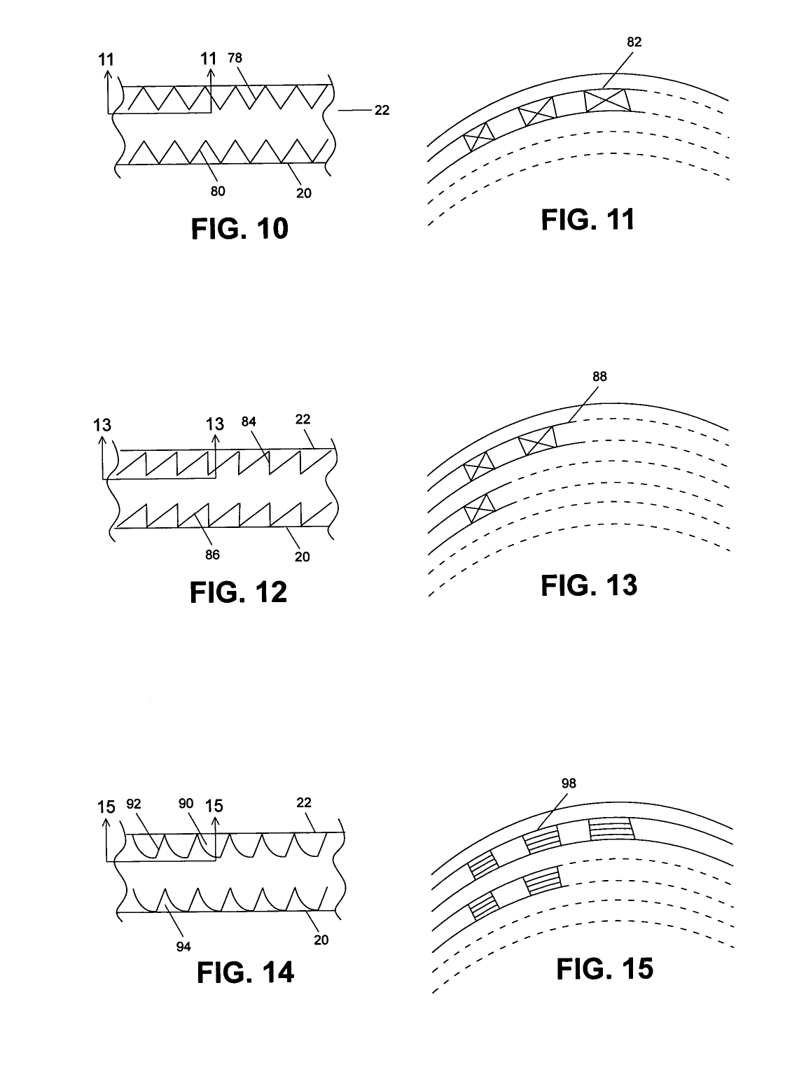

Any type of uneven surface can be used in place of the serrated surfaces previously mentioned. Thus, any two surfaces which will maintain sufficient engagement with one another to preclude rotation until a predetermined torque level is reached, can also be used for this purpose. However, in accordance with the present invention, it has been found that the serrated surfaces are most efficient and effective for this purpose. Thus, serrated surfaces of the types illustrated in FIGS. 10 through 15 can be employed. However, it should be understood that the serrated surfaces as shown in FIGS. 10 through 15 are only exemplary of the type of serrated surfaces which can be used in accordance with the present invention.

FIG. 10, for example, illustrates a typical saw tooth wave pattern as 78 on a lower face of a cap 22. In like manner, the upper surface of a base 20 is similarly provided with a saw tooth wave pattern 80 in the manner as shown in FIG. 10. In this case, the saw tooth wave pattern is actually comprised of a plurality of projections which will fall within the recesses formed by the saw tooth wave pattern 78. FIG. 11 shows that the saw tooth projections are arranged in arcuately shaped rows 82 which are radially spaced apart from one another and with each saw tooth projection arranged in each row.

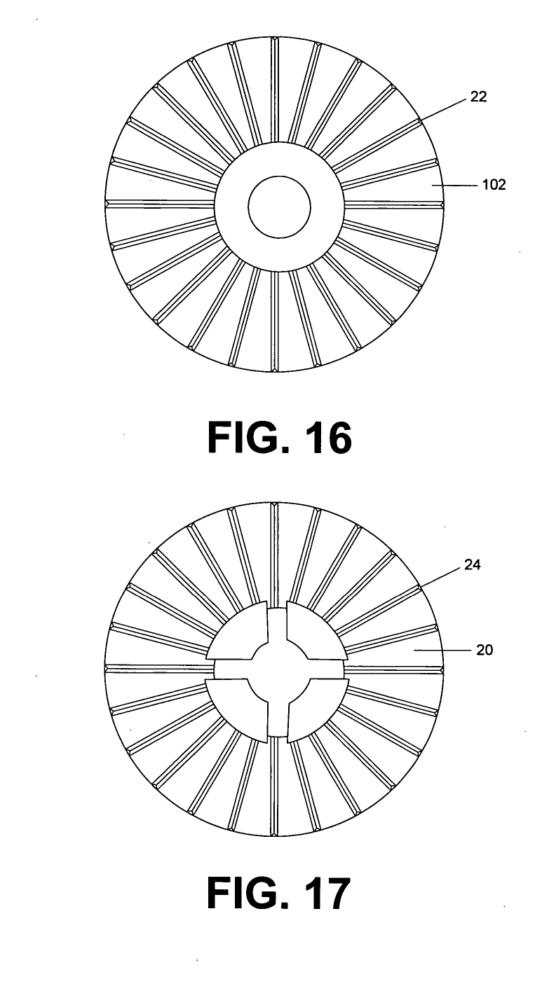

FIG. 12 illustrates a modified form of saw tooth wave pattern wherein each tooth is somewhat of a right triangle in the manner as shown. Thus, each saw tooth wave pattern has essentially a vertical wall 84 which engages a vertical wall 86 on an upper surface of the base 20. These projections are also arranged in circular arrays such as arcuately shaped rows 88 as shown in FIG. 13. FIGS. 14 and 15 illustrate a type of saw tooth pattern in which each tooth 90 has an arcuately shaped edge 92. In like manner, a base 20 is similarly provided with a tooth pattern 94 having a spike type projection 96 fitted within the groove between each tooth 90. In effect, the saw tooth pattern 94 is essentially a mirror image of the saw tooth pattern on the lower face of the cap 22.

Again, it can be observed that the pattern of projections in arcuate rows 98 is best illustrated in FIG. 15 of the drawings.

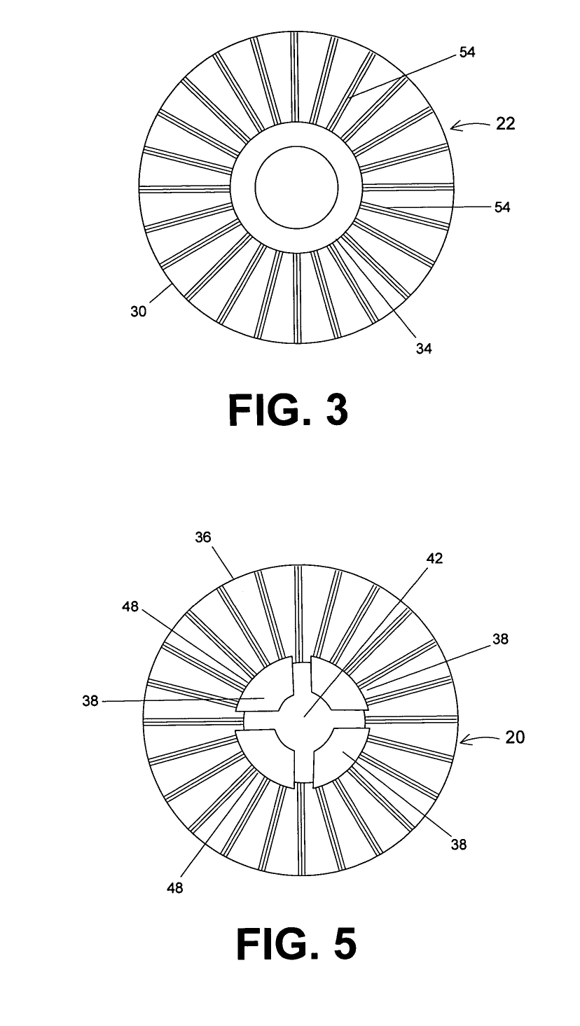

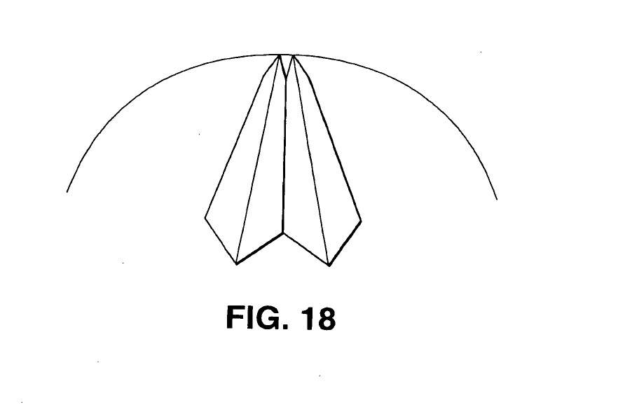

It should be understood that the serrated surfaces, as shown in the other figures such as FIGS. 1 through 9 are all projections arranged in arcuately shaped rows. FIGS. 16 through 18 illustrate an embodiment in which a cap and a base are provided with radially extending projections emanating from the center of each of these components to the outer peripheral edge thereof. Thus, there is a cap 22 having radial projections 102 and a base 20 having similar radial projections 24. These projections can adopt the shape as shown in FIG. 18 of the drawings. Otherwise, they can adopt differing shapes.

Thus, there has been illustrated and described a unique and novel torque limiting fastener and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

1. A torque limiting fastener in which the amount of torquing force applied thereto is limited such that torque can only be applied thereto to a predetermined amount, said torque limiting fastener comprising:
a) a first fastener section and a cooperating second fastener section which are releasably engageable with one another;
b) a pair of cooperatively engageable opposed fastener surfaces on said fastener sections and each having engageable serrated surface portions which are engageable in such manner that they rotate together when the torquing force of the fastener is less than a predetermined amount and slip when that force exceeds the predetermined amount; and
c) a projection on said first fastener section and capable of extending into an opening in said second fastener section and one of said projection or opening having a peripheral locking element extending into a groove in the other of said elements when force fitted thereinto to releasably lock said fastener sections together.

2. The torque limiting fastener of claim 1 further characterized in that said second engageable section is threadedly engageable with a threaded shaft and:
said first and second sections comprise apertures to receive said threaded shaft and threadedly engage said threaded shaft.

3. The torque limiting fastener of claim 2 further characterized in that said threaded shaft is projecting from a fixed object and is non-rotatable, such that when said sections are rotated about said shaft, they are tightened against and with respect to said fixed object.

4. The torque limiting fastener of claim 1 further characterized in that said fastener further comprises:
a) a first cooperatively engageable surfaces on said first section and which is serrated;
b) a second cooperatively engageable surface on said second section and facing said first section and which is also serrated; and
c) said second engageable surface being engageable with said first surface in such manner that the two sections will rotate together when a torquing force is applied to said second fastener section but which enables only said second fastener section to rotate and thereby cease any further application of torque when the amount of torque applied to said second section exceeds a predetermined amount.

5. The torque limiting fastener of claim 1 further characterized in that said projection is constructed in such manner that it is deformable to when forced to extend into said opening to thereby cause said locking element to extend into said groove.

6. The torque limiting fastener of claim 1 further characterized in that said projection is further comprised of:
a plurality of individual projection sections capable of being deformable relative to one another, such that the projection is deformable.

7. The torque limiting fastener of claim 1 further characterized in that said projection is further comprised of:
a) a plurality of circularly arranged individual projection sections with each spaced from one another such that each is capable of being deformed relative to one another; and
b) that said projection sections are also arranged with a circular aperture extending therethrough to receive a threaded rod.

8. The torque limiting fastener of claim 7 further characterized in that each of said projection sections have individual outwardly projecting locking portions which together form a circularly shaped locking element.

9. The torque limiting fastener of claim 1 further characterized in that said engageable serrated surfaces have radially extending serrations.

10. The torque limiting fastener of claim 1 further characterized in that said engageable serrated surfaces have circumferentially extending serrations.

11. A method of limiting torque applied by a fastener to a threaded rod when the fastener is turned about the rod, said method comprising:
a) releasably locking a first fastener section to a second fastener section;
b) threadedly securing said fastener section to said threaded rod;
c) causing engagement of serrated surfaces on said fastener sections when said sections are turned relative to said threaded rod; and
d) causing one of said sections to slip relative to the other of said sections when the amount of a torquing force applied to at least one of said sections reaches a predetermined amount.

12. The method of claim 11 further characterized in that said method comprises releasably locking said first and second fastener sections together by:
a) inserting a projection on one of said sections into an opening on the other of said sections; and
b) causing a locking element on the projection to extend into a groove in the opening.

13. The method of claim 12 further characterized in that said method comprises deforming said projection when forcing the projection into the opening.

14. The method of claim 13 further characterized in that the method further comprises deforming a plurality of projection sections relative to one another and thereby causing the locking element to easily move into the opening and which projection sections will return to their initial position after being inserted into said opening to releasably lock the fastener sections together.

15. A torque limiting fastener in which the amount of torquing force applied thereto is limited such that torque can only be applied thereto to a predetermined amount, said torque limiting fastener comprising:
a) a first fastener section and a cooperating second fastener section which are releasably engageable with one another;
b) a first cooperatively engageable surface on said first section and which is serrated;
c) a second cooperatively engageable surface on said second section and facing said first section and which is also serrated, and said second engageable surface being engageable with said first surface in such manner that the two sections will rotate together when a torquing force is applied to said second fastener section but which enables only said second fastener section to rotate and thereby cease any further application of torque when the amount of torque applied to said second section exceeds a predetermined amount; and
d) a releasable locking means operable between said first and second fastener sections so that said second fastener section becomes releasably locked to said first fastener section in such manner that one of the sections is initially rotatable relative to the other.

16. The torque limiting fastener of claim 15 further characterized in that said second engageable section is threadedly engageable with a threaded shaft and:
said first and second sections comprise apertures to receive said threaded shaft and threadedly engage said threaded shaft.

17. The torque limiting fastener of claim 16 further characterized in that said threaded shaft is projecting from a fixed object and is non-rotatable, such that when said sections are rotated about said shaft they are tightened against and with respect to said fixed object.

18. The torque limiting fastener of claim 15 further characterized in that:
a) a first cooperatively engageable surfaces on said first section and which is serrated;
b) a second cooperatively engageable surface on said second section and facing said first section and which is also serrated; and
c) said second engageable surface being engageable with said first surface in such manner that the two sections will rotate together when a torquing force is applied to said second fastener section but which enables only said second fastener section to rotate and thereby cease any further application of torque when the amount of torque applied to said second section exceeds a predetermined amount.

19. The torque limiting fastener of claim 16 further characterized in that said locking means comprises a projection on said first fastener section and capable of extending into an opening in said second fastener section and one of said projection or opening having a peripheral locking element extending into a groove in the other of said elements when force fitted thereinto to releasably lock said fastener section together.

20. The torque limiting fastener of claim 19 further characterized in that said projection is constructed in such manner that it is deformable to when forced to extend into said opening to thereby cause said locking element to extend into said groove.

21. The torque limiting fastener of claim 20 further characterized in that said projection is further comprised of:
a plurality of individual projection sections capable of being deformable relative to one another such that the projection is deformable.
